(19) United States
(12) Patent Application Publication
(10) Pub. No.: US 2022/0020034 A1
(43) Pub. Date: Jan. 20, 2022

(54) MAXIMIZING CHANNEL YIELD IN DIGITAL TRANSACTION

(71) Applicant: INTERNATIONAL BUSINESS MACHINES CORPORATION, Armonk, NY (US)

(72) Inventors: Sanket Jain, Gurgaon (IN); Mukundan Sundararajan, Bangalore (IN); Saurav Shekhar, Gurgaon (IN)

(21) Appl. No.: 16/929,442

(22) Filed: Jul. 15, 2020

(51) Int. Cl. G06Q 30/02; G06F 16/901; G06F 16/23; G06N 20/00

(52) U.S. Cl. CPC G06Q 30/0201; G06N 20/00; G06F 16/2379; G06F 16/9024

(57) ABSTRACT

A method, computer system, and computer program product for dynamic digital channel journey analysis are provided. The embodiment may include obtaining information related to user page accesses and flows. The embodiment may also include creating a period graph for a measurement period. The embodiment may further include computing an initial yield leakage value for the measurement period. The embodiment may also include creating a temporal reference. The embodiment may further include updating the period graph based on the yield leakage value and the temporal reference. The embodiment may also include identifying a link where the yield leakage value is high and where the link leads to.

### BACKGROUND

The present invention relates, generally, to the field of computing, and more particularly to customer journey analytics.

Customer journey analytics relates to systems capable of analyzing every touchpoint that a customer interacts with across multiple channels on web pages over time. Customer journey analytics may give marketers and customer experience professionals a useful tool to analyze and improve business practices at a personal level. Based on the analysis of a tremendous amount of data in real-time, marketers may discover the most important customer journey sand prioritize those opportunities that may significantly impact business goals such as increasing revenues and improving customer experience.

### SUMMARY

According to one embodiment, a method, computer system, and computer program product for dynamic digital channel journey analysis are provided. The embodiment may include obtaining information related to user page accesses, data provided by the user and choices the user made and page flows. The embodiment may also include creating a period graph for a measurement period. The embodiment may further include computing an initial yield leakage value for the measurement period. The embodiment may also include creating a temporal reference. The embodiment may further include updating the period graph based on the yield leakage value and the temporal reference. The embodiment may also include identifying a link where the yield leakage value is high and where the link leads to.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a dynamic digital channel journey analysis process according to at least one embodiment;

FIG. 3 is an exemplary diagram depicting a graph showing online flows and exits according to at least one embodiment:

FIG. 4A-4B illustrate exemplary tables representing pages and engagement values according to at least one embodiment;

FIGS. 5A-5B illustrate exemplary graphs representing temporal references based on information retrieved from FIGS. 4A-4B according to at least one embodiment;

FIG. 6 is a block diagram of internal and external components of computers and servers depicted in FIG. 1 according to at least one embodiment;

FIG. 7 depicts a cloud computing environment according to an embodiment of the present invention; and

FIG. 8 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to customer journey analytics. The following described exemplary embodiments provide a system, method, and program product to dynamically analyze digital channel journey from a request for a service to subsequent connects into channel tracks and path. For instance, the level of engagement of a user to a path may be determined by additional information that the user may add as the user progress from one page of a web site to another toward the final termination nodes of a flow of a specific business. Therefore, the present embodiment can improve the technical field of customer journey analytics and functioning of web server software by identifying and analyzing those activities in which a user engage in until the user terminates the user's journey on a particular web page or online transactions, such that an improved conversion and yield of overall online business channels that may increase the business revenue may be achieved.

As previously described, customer journey analytics relates to systems capable of analyzing every touchpoint that a customer interacts with across multiple channels on web pages over time. Customer journey analytics may give marketers and customer experience professionals a useful tool to analyze and improve business practices at a personal level. Based on the analysis of a tremendous amount of data in real-time, marketers may discover the most important customer journeys and prioritize those opportunities that may significantly impact business goals such as increasing revenues and improving customer experience.

One of the challenges with a multi-channel business transaction approach may be that the impersonality of the digital transactions may lead to a high volume of quick drop off even if the business leads may seem to be good. Such digital transactions may be processed on web pages, bots, or other technology-driven touchpoints. In case of web page transactions, a business could have its links placed in the webpages from a platform for a particular industry or in other similar businesses either through ad-links or quid pro quo arrangements beyond their webpages on the business URLs. A user may exit a webpage either because the information needed has already been obtained or the user needs to choose one of the other options or links in such web pages which may lead to other businesses' webpages. For example, the user may have been just looking for certain information without a reason to complete a transaction or the user may have received a better offer from other business webpages. When the latter is the case, it is the latter class of reasons for the dropping of their digital journey, then a business would need to be aware of the issues and resolve such issues so that such leakages would convert to revenues and the website channel yield would improve. Today, various statistics are available to summarize conversion rates in digital channel realms, but most of the studies focus on web site channels. However, there are not too many analytics that may enable business organizations to determine where the organizations can improve business to business relationships to improve their channel yield and ultimately their business revenue.

Today, known solutions include analytics of incomplete journey steps to determine if websites or channels need improvement or if any link between the websites is broken. Various link analytics may explain as to why some users drop before a transaction is completed. The disadvantages of the above method may be that the method only focuses on the customer side of the transaction and not on the other business entities that are competitors or partners that sell similar products or services. Further, the above analysis does not factor in the cases where a user through a link has been taken to additional pages in the flow or the user's visit was limited to the first page and the user decided to drop before visiting other pages. If a link from another business directs the user to the current business' website and there is a drop, it may be possible that such a drop is included in the statistical report as described above, but tracking the flow of interactions beyond the first page may not be tracked easily. As such, it may be advantageous to, among other things, implement a system capable of improving the functioning of web server software by analyzing the flow and the level of engagement at different levels, using graph theory, to generate a depth value and computing from such a graph the paths of user escape or exits due to different flow of e-commerce paths and identify intersecting paths that have the highest amount of intersections in the channel paths to generate a channel yield loss ranking, such that the business organization may better prepare for the future business to business negotiations which may, in turn, lead to increase in the profitability of the organizations.

According to one embodiment, the present invention may apply a vector graph theoretic approach to dynamically analyze a digital channel journey from an initial point of a customer inquiry or request for a product or a service to subsequent connects into the channel tracks and paths. In at least one other embodiment, the present invention may also measure and analyze the distance from any webpage to a termination point which may represent the closeness to completion of a customer transaction and assign the channel or point where any drop or loss takes place higher weight or ranking such that a business organization may improve or enhance the channel flows by reducing potential flow drops or exits.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for identifying yield loss or drops from various digital channel flows based on a graph theory that may analyze the flow and the levels of engagement at different levels of the channels, thereby providing a depth value for each flow of the channels.

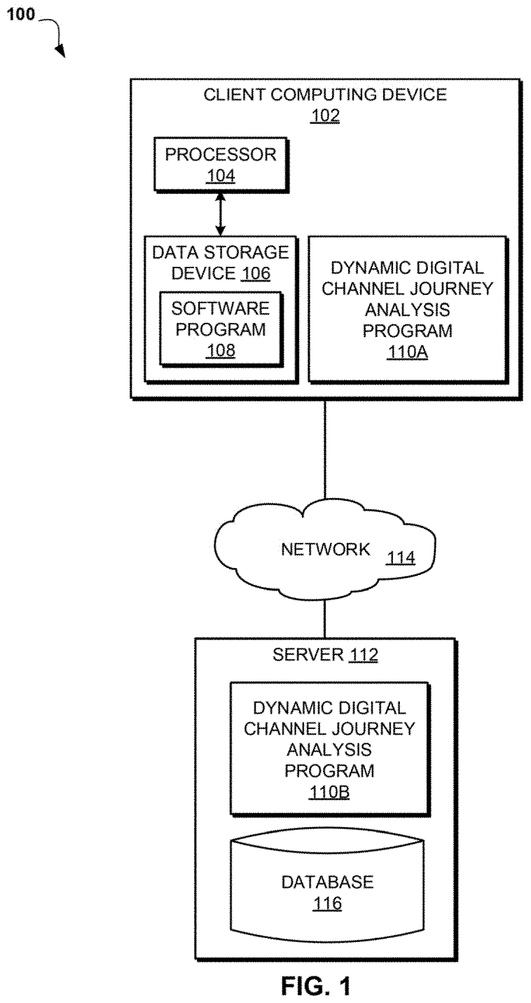

Referring to FIG. 1, an exemplary networked computer environment 100 is depicted according to at least one embodiment. The networked computer environment 100 may include a client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

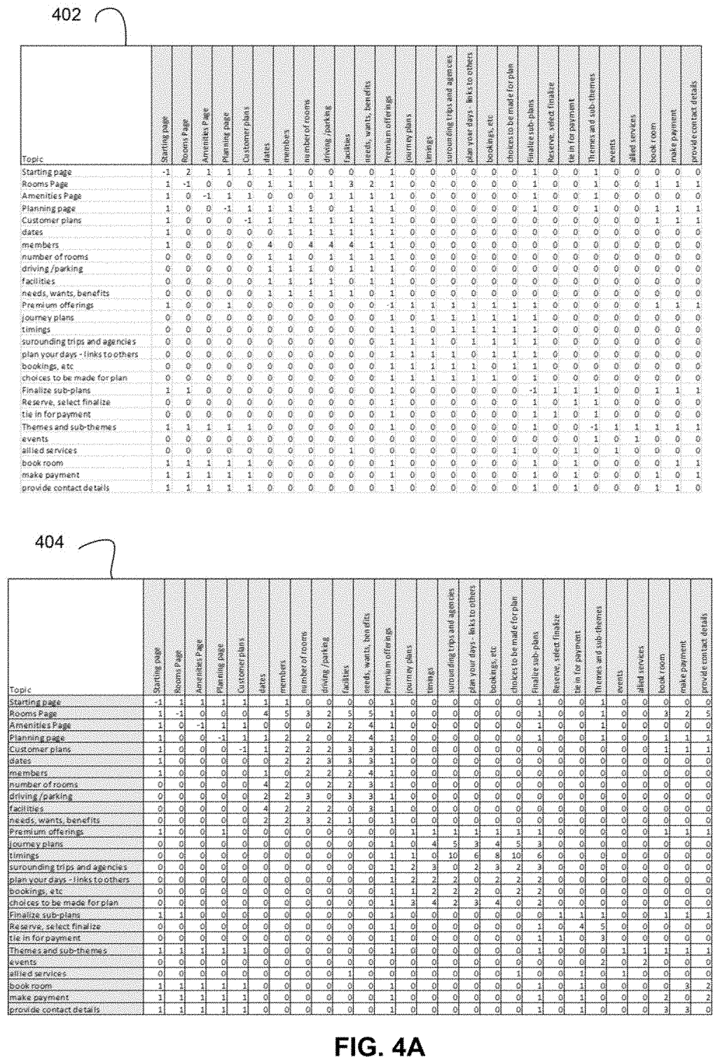

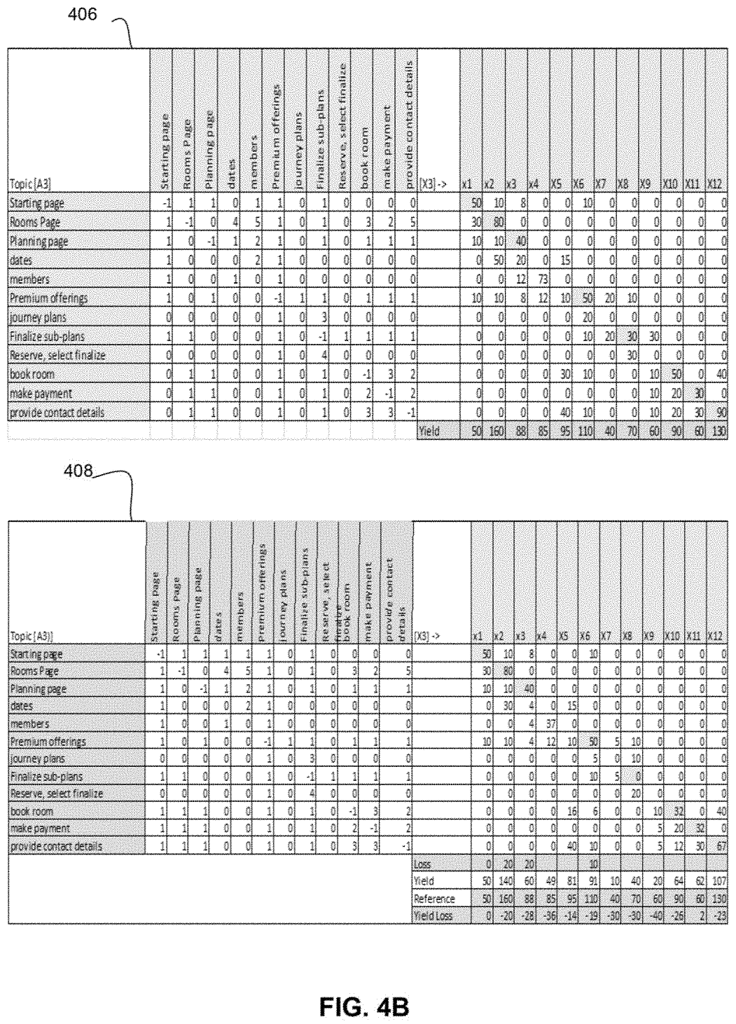

Client computing device 102 may include a processor 104 and a data storage device 106 that is enabled to host and run a software program 108 and a dynamic digital channel journey analysis program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a dynamic digital channel journey analysis program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

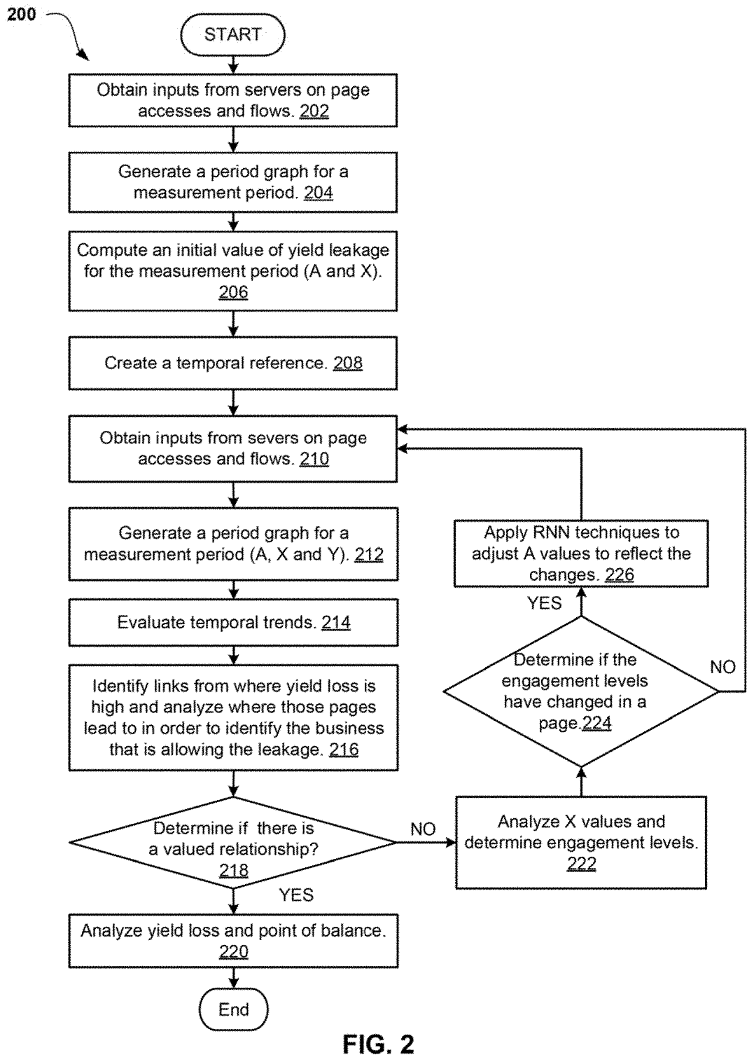

According to the present embodiment, the dynamic digital channel journey analysis program 110A, 110B may be a program capable of identifying links where yield loss is high and analyze where such links lead to (i.e. webpages). The dynamic digital channel journey analysis process is explained in further detail below with respect to FIG. 2.

Referring to FIG. 2, an operational flowchart illustrating a dynamic digital channel journey analysis process 200 is depicted according to at least one embodiment. At 202, the dynamic digital channel journey analysis program 110A, 110B obtains inputs from servers on page accesses and flows. According to one embodiment, the dynamic digital channel journey analysis program 110A, 110B may receive input information from the database 116. Such input information may include the number of users that visited particular webpages and how many of those users moved onto another page from a link or due to a page to page interaction. In at least one other embodiment, based on starting pages and the next pages a user traverse, the dynamic digital channel journey analysis program 110A, 110B may generate a graph path. The number of traversals in a particular measurement period may become a value of an edge. In at least one embodiment, nodes in a graph may represent a webpage URL or a link on a webpage, and edges in the same graph may represent a webpage and any information exchanged between an end-user and the website. Engagement may be user inputs of certain additional data or selection of checking off a button or a box. The number of such engagement may be shown as self-loop on an end in a graph. One edge may have multiple values (1, 2, . . . n) and have different values for different sets of users who may engage differently on each webpage. For example, in a case of the hospitality industry, such information could include a number of nights or rooms that a user wants to book, family or group count, parking need, special facilities needed or a selection from a provided list of options with checkboxes.

At 204, the dynamic digital channel journey analysis program 110A, 110B generates a period graph for a measurement period. In at least one embodiment, the dynamic digital channel journey analysis program 110A, 110B may create a period graph for a measurement period using an “X” value representing the number of unique traversals between two nodes in a measurement period for each user and an “A” value representing a coefficient matrix which is “n×n” matrix with “w” layers based on the levels of engagement. If certain information is requested on a webpage and the requested information is fulfilled on that page, it may be considered being a self-loop and the self-loop may provide the number of user actions carried out and when the user moves to another webpage from the original page. The amount of information provided by the user may be considered as an increase in the user engagement and the coefficient value A may be increased as the number of fields of such information provided. Such information may include information provided in text format, dropdown format, checkboxes or spoken or video inputs. In one embodiment, a measurement period may be defined by a business organization and may be hours, days, or weeks. In at least one other embodiment, the dynamic digital channel journey analysis program 110A, 110B may compute and generate a matrix map using the values X and A. For example, if a flow starts from node 1 and node 2 with different edge values and the distance to the final termination point is five steps from node 1 and eight steps from node 2, then a sample matrix map may be generated as follows:

$${A}_{1} = [ \begin{matrix}- 1 & 0 & 0 & 0 & 0 & 1 & 0 & 0 & 0 & 1 & 0 & 0 & 0 & 1 & 0 & 0 & 1 & 0 & 0 & 1 & 0 & 0 & 0 & 0 & 0 & 0 & 0\end{matrix} ] \\ [ \begin{matrix}0 & - 1 & 0 & 0 & 0 & 0 & 0 & 1 & 0 & 0 & 1 & 0 & 0 & 0 & 1 & 0 & 0 & 1 & 0 & 1 & 0 & 0 & 1 & 0 & 1 & 0 & 1\end{matrix} ] \\ [ \begin{matrix}0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 ]\end{matrix}$$

A₁ may be in the first two dimensions with values of (−1, 0, 1) where there may be no additional selection or information provided in different data fields by a user.

$${A}_{2} = [ \begin{matrix}- 1 & 0 & 0 & 0 & 0 & 1 & 0 & 0 & 0 & 1 & 0 & 0 & 0 & 1 & 0 & 0 & 1 & 0 & 0 & 1 & 0 & 0 & 0 & 0 & 0 & 0 & 0\end{matrix} ] \\ [ \begin{matrix}0 & - 1 & 0 & 0 & 0 & 0 & 0 & 1 & 0 & 0 & 1 & 0 & 0 & 0 & 1 & 0 & 0 & 1 & 0 & 2 & 0 & 0 & 4 & 0 & 1 & 0 & 1\end{matrix} ] \\ [ \begin{matrix}0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0\end{matrix} ]$$

In the above second flow A₂, the user entered data in 2nd and 4th fields on a webpage. Dimension may be used to define the extents of user engagement on a webpage. As different users may have different levels of engagement by exchanging different levels of information on the same page, the graph may become three dimensional. As the engagement level increases when the user adds data to a webpage, another dimensional entry may be added to show that the level of engagement increases with the increased coefficient values (2, or 3 or 4, etc).

The X matrix may be an edge count matrix. X₁ and X₂ may be represented as follows:

$${X}_{1} = [ \begin{matrix}2 & 0 & 0 & 0 & 0 & 2 & 0 & 0 & 0 & 2 & 0 & 0 & 0 & 1 & 0 & 0 & 1 & 0 & 0 & 1 & 0 & 0 & 0 & 0 & 0 & 0 & 0\end{matrix} ] \\ [ \begin{matrix}0 & 1 & 0 & 0 & 0 & 0 & 0 & 1 & 0 & 0 & 1 & 0 & 0 & 0 & 1 & 0 & 0 & 1 & 0 & 1 & 0 & 0 & 0 & 1 & 0 & 1 & 0\end{matrix} ] \\ [ \begin{matrix}0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0\end{matrix} ]$$

$${X}_{2} = [ \begin{matrix}0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0\end{matrix} ] \\ [ \begin{matrix}0 & 2 & 0 & 0 & 0 & 0 & 0 & 2 & 0 & 0 & 2 & 0 & 0 & 0 & 2 & 0 & 0 & 2 & 0 & 2 & 0 & 0 & 2 & 0 & 2 & 0 & 2\end{matrix} ] \\ [ \begin{matrix}0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0 & 0\end{matrix} ]$$

And the below may be a regular matrix representation of the X1 and X2 that are shown in a transposed form above.

$$\begin{matrix}{X}_{1} = [ 2 \; 0 \; 0 & {X}_{2} = [ 0 \; 0 \; 0 \\ 0 \; 1 \; 0 & 0 \; 2 \; 0 \\ 0 \; 0 \; 0 & 0 \; 0 \; 0 \\ 0 \; 0 \; 0 & 0 \; 0 \; 0 \\ 2 \; 0 \; 0 & 0 \; 0 \; 0 \\ 0 \; 1 \; 0 & 0 \; 0 \; 0 \\ 0 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 & 0 \; 0 \; 0 \\ 2 \; 0 \; 0 ] & 0 \; 0 \; 0 ]\end{matrix}$$

In one embodiment, the dynamic digital channel journey analysis program 110A, 110B may use the above matrix map to create a period graph. In at least one embodiment, a period graph may be a graph showing links and different engagement levels in a link with both the level of engagements as well as the traversals.

At 206, the dynamic digital channel journey analysis program 110A, 110B computes an initial value of Y that represents a yield leakage for the measurement period. In at least one embodiment, the dynamic digital channel journey analysis program 110A, 110B may compute a Y value by multiplying the coefficient value A by the value X divided by a V value. V value may be a value that may represent the number of steps to the completion of a transaction. A times X may be computed and Yₙ=AXₙ may be accumulated daily, where Yₙ is the sum for path Xₙ for which A is fixed and is the sum over multiple periods. In at least one other embodiment, Y may be calculated using the formula: Y=(A₁X₁+A₂X₂)/V. Y is the sum across different path matrices over a given period.

At 208, the dynamic digital channel journey analysis program 110A, 110B creates a temporal reference. A temporal reference may be a condition of a time space where there are no leakages and all transactions conclude with a revenue for a company. Such a reference may be predefined or configured manually in the beginning to be set as an initial reference. According to one embodiment, the dynamic digital channel journey analysis program 110A, 110B may create a temporal reference with respect to the computed Y values. If a Y value of one node is higher than another Y value obtained from another node, that may mean the first node is allowing more yield leakage than the other node. The purpose of creation of a temporal reference is also to save certain data related to Y values such that the dynamic digital channel journey analysis program 110A, 110B may modify or update the leakage analysis based on the increased engagement of multiple users or increased number of users throughout the next measurement period.

At 210, the dynamic digital channel journey analysis program 110A, 110B obtains inputs from servers on page accesses and flows. According to one embodiment, the dynamic digital channel journey analysis program 110A, 110B may obtain said information from the same server as described in step 202. If the first measurement period was for week1, then the dynamic digital channel journey analysis program 110A, 110B may update values A, and X, based on the data obtained in week2. The dynamic digital channel journey analysis program 110A, 110B may find a change in the engagement level in a webpage and update A, X, and Y values accordingly. The number of data points provided by a different user reflecting an engagement level may change the value of A and based on the number of users in a period taking the same path-fully or partially—may change the value of X. For example, in step 202, a period graph may be created initially and only once based on the historical data from outside servers, but in step 201, temporal graphs may be created for each of different time period and may repeat the process in a loop.

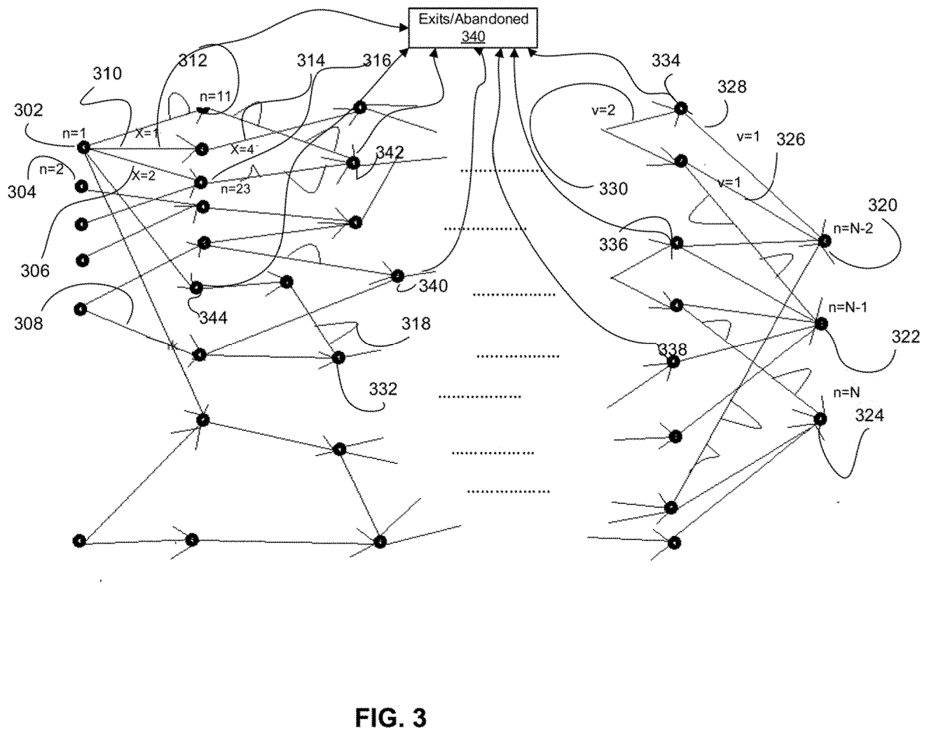

At 212, the dynamic digital channel journey analysis program 110A, 110B creates a period graph for the measurement period based on the values, A, X and Y. According to one embodiment, the dynamic digital channel journey analysis program 110A, 110B may update A, X and Y values based on the next measurement period and generate a period graph based on the updated data. The updated period graph may depict relationships of A, X, and Y in a standard bar graph, histogram, line graph, etc. Based on such relationships, a user may find useful information as to where the number of leakages (e.g. page drop out) is higher than the other or whether the dropped-out page had many exchanges of information or user engagements (e.g. providing personal information necessary for completing a transaction). An exemplary period graph is shown in FIG. 3. A period graph may be the representation of all the possible links and paths that a user may take and various engagement points where the user may exchange the user information when requested by a webpage. It may be a single image that captures all the AₙXₙ combinations for a time period. On the other hand, splitting AₙXₙ to several AXₙ may provide a temporal reference for analysis purposes.

At 214, the dynamic digital channel journey analysis program 110A, 110B evaluates temporal trends. According to one embodiment, the dynamic digital channel journey analysis program 110A, 110B may analyze the relationships between the values A, X, and Y to determine temporal trends. While a temporal reference may be a graph when all the user journeys terminate at the last level of each different level of user engagement, a temporal trend may represent both the engagement level and the business that may have diverted due to the users leaving the path before the completion step in a given period of time, such as day, week, months or other specified period of time. For example, temporal trends may represent certain pages or channel paths that may have more user drop-out ratios than other pages or paths. Also, the relationship between the values X and the leakage value Y may represent identify the direction of the users who have dropped out on certain pages. The dynamic digital channel journey analysis program 110A, 110B may further determine what kinds of information the users provided until the users dropped out before moving onto the next node.

At 216, the dynamic digital channel journey analysis program 110A, 110B identifies links where yield loss is high and analyzes where those links lead to or identify the businesses that are allowing such leakage. According to one embodiment, the dynamic digital channel journey analysis program 110A, 110B may compare one or more webpages that indicate Y value is higher than the preconfigured threshold value and rank the highest page that generates the highest ratio of yield leakage. In yet another embodiment, the dynamic digital channel journey analysis program 110A, 110B may trace the users' journey path or links that the users clicked from the point where the users dropped out of the page and find where those users ended up being on other business organization's webpage. In at least one other embodiment, the dynamic digital channel journey analysis program 110A, 110B may generate a summary of the identification of such businesses that caused the page dropouts or yield leakage. Such business may be direct competitors of the original service/product provider of the original webpage.

At 218, the dynamic digital channel journey analysis program 110A, 110B determines if there is a valued relationship between the businesses. According to one embodiment, the dynamic digital channel journey analysis program 110A, 110B may identify the business transaction completed on other webpages after the user dropped from the previous paths. For example, if a user was looking to buy a piece of furniture on a webpage, but the user ended up being on other company's web page and purchasing a hotel reservation, then the dynamic digital channel journey analysis program 110A, 110B may determine that yield leakage was caused by the hotel reservation site and determine if there is any business relationship between the furniture site and the hotel reservation site. If there is no such a business relationship (Step 218 “No” branch), the dynamic digital channel journey analysis program 110A, 110B may continue to step 222 to analyze “x” values and determine engagement levels. If there is a business relationship (step 218 “Yes” branch), then the dynamic digital channel journey analysis program 110A, 110B may continue to step 220 to analyze yield loss and point of balance.

At 220, the dynamic digital channel journey analysis program 110A, 110B analyzes yield loss and point of balance. According to one embodiment, the dynamic digital channel journey analysis program 110A, 110B may summarize the level of user engagement and degree of yield loss on each page and generate a report for a business decision-maker. The business decision-maker then may better prepare for a business to business negotiation and find a point of balance where either side of businesses may generate steady revenue without losing customers due to said counterpart's business. In the above example, the dynamic digital channel journey analysis program 110A, 110B may generate a report that may assist a user in identifying the main reason why a business is experiencing a high yield loss at a particular point in a transaction path. For instance, senior management of a business organization may want to know why a customer clicked the link and booked a hotel room while looking to purchase a piece of furniture on a webpage. There may be coupons targeted to such customers or reciprocal reward programs between the furniture eCommerce site and the hotel room booking site. The dynamic digital channel journey analysis program 110A, 110B may analyze said relationships between two businesses and determine how the relationships are helping either business if any.

At 222, the dynamic digital channel journey analysis program 110A, 110B analyzes x values and determine engagement levels. The x values computed in step 206 may be based on the historical data including the leakage/loss paths and the points where such leakages are taking place. Here, with temporal analysis on specific traversal paths, if sufficient engagement information is being provided and there is a leakage or exit, adjusting the weights in the A matrix by a machine learning system that may improve the functioning of web server software to assist businesses in resolving issues of losing sales to other businesses. According to one embodiment, the edge value represented by “x” is the number of unique traversals between two nodes in a measurement period for each user. In at least one other embodiment, the edge value “x” may represent an actual number of unique users in a measurement period, as each unique user may have one unique traversal in a certain instance depending on a type of business or sales transaction. The dynamic digital channel journey analysis program 110A, 110B may analyze the number of unique traversals and identify the engagement level involved in each unique traversal. For example, when a user wants to book a hotel for a night and reviewing various types of rooms and rates on a hotel booking site, the dynamic digital channel journey analysis program 110A, 110B may analyze whether the user's traversal from one site to another site shows a unique sign of engagement level, such as repeatedly providing the same information or going back and forth between particular two pages. In at least one embodiment, a user engagement level may be determined not only based on user-provided data but also include any additional multi-media material, such as linking of social media sites or other links by the user for various operations or uploading images including photos or videos.

At 224, the dynamic digital channel journey analysis program 110A, 110B determines if engagement levels have changes in a page. According to one embodiment, the dynamic digital channel journey analysis program 110A, 110B may compare one or more measurement periods and determine if the user engagement measured based on the provided by a user has changed on a webpage. At least two different measurement periods may be needed. Even within a single measurement period, if new levels of information is being provided by a user and is not found in a reference period graph, a new A matrix may be created and the period graph may be updated accordingly. Typically, if a webpage has had a high ratio of customer dropout, users' engagement level would not change dramatically over a certain time period. However, if there is a change in an engagement level over the past few months or week, for example, it would indicate that certain change or business strategy initiated by counterparty businesses has caused an increase in the dropout rate and yield leakage. If the engagement level has changed (step 224, “Yes” branch), the dynamic digital channel journey analysis program 110A, 110B may continue to step 226 to apply RNN (recurrent neural network) techniques to adjust A values to reflect the changes. If the engagement level has not changed (step 224, “No” branch), the dynamic digital channel journey analysis program 110A, 110B may return to step 210.

At 226, the dynamic digital channel journey analysis program 110A, 110B applies RNN techniques to adjust A values to reflect the changes. According to one embodiment, the dynamic digital channel journey analysis program 110A, 110B may update a coefficient value “A” when a yield leakage value “Y” shows an increasing trend. In another embodiment, machine learning systems may be updated based on the increased “Y” value and the increased coefficient value “A”. The dynamic digital channel journey analysis program 110A, 110B may utilize a recurrent neural network model to train the machine learning systems. As previously described, A time X may be computed each day and Yₙ=AXₙ may be accumulated. In another embodiment, a coefficient value may be increased as the number of fields of user information provided increases. More engagement level may result in changes to the value of A to represent higher weightages if certain data brings more value to the business. The dynamic digital channel journey analysis program 110A, 110B may then return to step 210 to obtain other inputs from servers on page flows and accesses based on the updated coefficient value “A”. In yet another embodiment, some nodes need to be considered having a higher weight than other nodes, and adjustment of the coefficient value “A” may determine whether a certain page needs another review in terms of whether to maintain a link or drop the link as a yield sensitivity is low.

Referring now to FIG. 3, an exemplary diagram depicting a graph showing online flows and exits is depicted according to at least one embodiment. According to one embodiment, the starting node 302 and the node 304 may be several web URLs from which customer requests area obtained for information and the edge 306, 308 and 310 may represent edges representing webpages and the information exchanged between a user and a website. Such information, for instance, may be the number of the night, number of rooms, family or group count when a user tries to book a hotel. The edge 306 may have an edge value 2, the edge 310 may have an edge value 1, and the edge 314 may have an edge value 4 depending on the number of unique traversals between two nodes. For example, the edge 306 may have two traversals between node 302 and node 316. The edge 308 may be one of the links selected from one or more options available for a user to select. In this example, the edge 318 may be data selection or data submission on a webpage or node 332 and in this case, a user may have started from node 302 and followed the path and finally submitted critical information at the node 332. In this example, the value “v” may be the number of steps required before confirming a booking of a hotel from a web page if such paths had been taken without any dropout. The edge 326 and the edge 328 may have the v value of 1 and that may represent that there is only one step remaining to complete a transaction (i.e. booking is completed) at the node 320. On the other hand, the edge 330 has the v value of 2 as there may be two steps to completed before reaching node 320 from node 334. In this example, there may be three different terminal points of the transaction. For instance, node 324 may be a webpage where a user is required to submit personal information such as the contact information after the completion of booking or payment. The node 322 may represent a point where a user completed the payment and the node 320 may represent the point where a booking is confirmed. In this example, the nodes 334, 336, 338, 340, 342 and 312 may represent the points where a user exited or abandoned before booking is completed and those nodes are collectible represented as a node group 340. In this graph, node 316 may be an exit that has the highest yield loss. The combination of the exits with the weights and how many subsequent steps with high weights may influence which exit has the highest yield loss. The dynamic digital channel journey analysis program 110A, 110B may perform a further analysis as described in FIG. 2 to identify why potential customers have exited from this page and the relationship with the business owning this page should be analyzed such that the exits from this page may be reduced in the near term.

Referring now to FIG. 4A, exemplary table 402 and table 404 are depicted according to one embodiment. Table 402 may show that the primary table of pages and the links between the pages. Table 404 may represent a table that is a variation of table 402 where the engagement numbers are provided for the pages. The dynamic digital channel journey analysis program 110A, 110B may carry out an analysis of a business portal linked from a business platform and create the map of pages, links to other pages and the fields where users can provide data or make user choices. Based on the amount of data that users may provide, Table 402 and Table 404 may be generated. Each number in the table may represent an A value and depending on the number of combinations of the amount of data provided or choices made by the users, the value may increase to A₃, . . . Aₙ. In one embodiment, A value of −1 may show that it is the starting point of a digital journey and a value of 0 or 1 may represent whether there is no link or at least one link between two pages. A value higher than 1 may represent that more information has been provided in the source page when moving to the next target page in the path. For example, a user may be requested to provide the user information five times when completing the transaction on the “Rooms Page”.

Referring now to FIG. 4B, exemplary table 406 and 408 are depicted according to one embodiment, table 406 may be a variation of table 404 where only key pages and links may be taken out for illustrative purposes to show the calculations and general implementation of the current invention. There may be two sub tables: the first one may be related to the value A and the second to the value X. Table 408 may represent a real world scenario where there has been journey leakages that all the started journeys did not conclude at the file end points but a user may have moved to other links from the page to other business partners' pages. In one embodiment, the paths traversed by different customers of a business in a reference period may be taken and be found to primarily be a subset of the different pages, links and fields populated that leads to A₃ in the table 406 and 408. If all the paths lead to successful revenue generation for the business through either payment or booking or a request to make a contact which may be the three endpoints for successful journeys in the portal in the example, the temporal reference of number of clients journeys in the different paths may be created such as X₃ in the table 406. These data may be used to generate a period graph where an A value of 0 means no digital journey made and other values other than 0 may show the number of digital journey that were made in the path. In another embodiment, for a measurement period, full and partial journeys where the users have moved out of the portal at different points after levels of engagement measured by the links clicked in the journey and the data provided may be measured shown as X₃ in the table 408. The row representing “loss” may show the number of users who made only partial journeys and moved on other business in different pages. The yield may be computed with unitary weights shown by the values in A₃. The yield loss in the table may represent the difference between the yield if the users had completed all the journeys successfully to the yield computed with the full and partial journeys that shows potential revenues or opportunity loss due to the users moving to other business links from different pages in that portal that may have cross-selling links with other businesses.

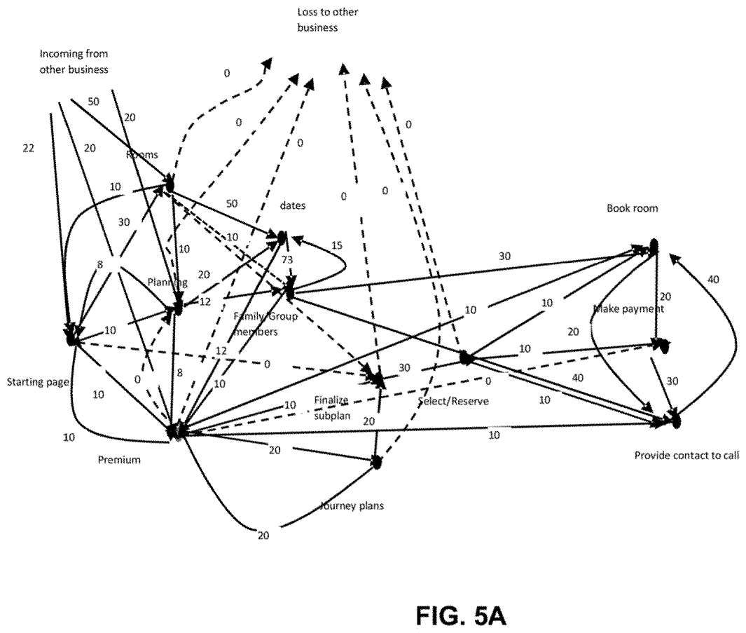

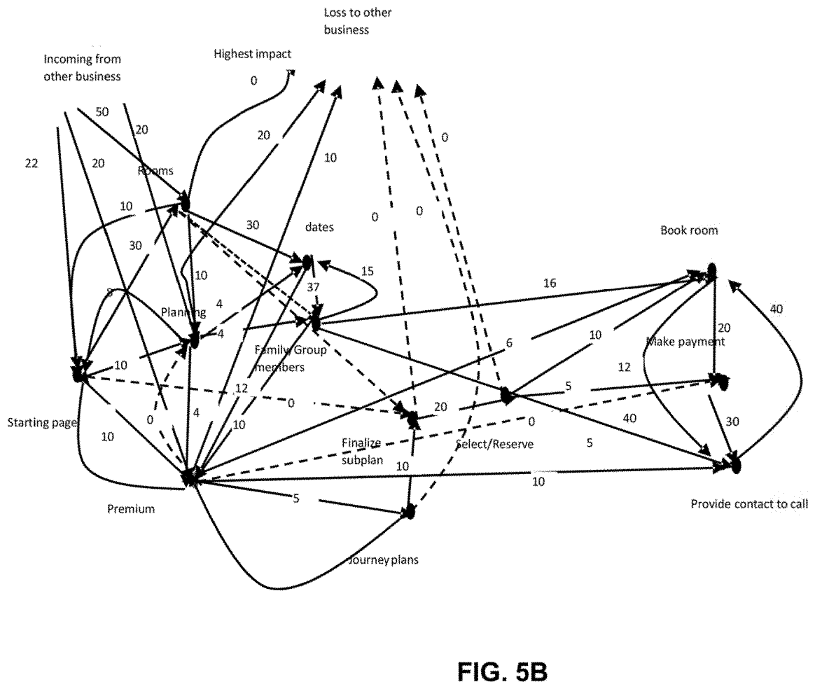

Referring now to FIG. 5A, an exemplary graph showing a possible digital journey traversed that reaches the successful outcome for a business—for each of the digital journeys by users—is depicted according to one embodiment. Such an exemplary graph may be generated based on the table 406 to create a temporal reference. In one embodiment, all the journeys are assumed successful and the weight of information leverage may be kept as one in the different paths and the numbers against the paths between two pages may show the number of traversal in the digital journeys of various users have taken in a reference period. Since all journeys are successful in this example, the exits may show a value of “0”. The graph may show the yield values between each node. For example, the node “Rooms” to the node “dates” may have a yield value of 50 showing 50 digital journey parts made by users from “Rooms” to “dates” with unitary weights for this link and the node “dates” to the node “Family/Group members” may have a yield value of 15. The higher yield value may represent more information value or revenue that the page transfer from the “Rooms” related page to “dates” related pages than the page transfer from the “Family/Group members” page.

Referring now to FIG. 5B, a graph representing a real-world scenario is depicted according to one embodiment. FIG. 5B may represent journeys where all the users traversed the same paths and provide the same level of information while engaging in the digital traversal in a given time period with may provide one A₁ value and X₁ value for a time period. There may be another A₂ and a corresponding X2 for the same period that traverses with no additional information provided in each page. In one embodiment, for a given time period, multiple Aₙ and Xₙ values may be obtained based on different types of references created as in FIG. 5B. The yield loss in this example may show that 20 users left after reaching the dates page and the analysis may show that another partner business link that may have been clicked by users. The exits shown in this graph may represent the exits to other businesses and the lost revenue or opportunity for the business to the other businesses. In another embodiment, periodic analysis for all the Aₙ paths and information combinations may be automatically performed and consolidated to show the overall successful yields and exits.

It may be appreciated that FIGS. 2-5 provide only an illustration of one implementation and do not imply any limitations with regard to how different embodiments may be implemented. Many modifications to the depicted environments may be made based on design and implementation requirements. For example, in at least one embodiment, the dynamic digital channel journey analysis program 110A, 110B may utilize other known deep learning models to adjust a coefficient value depending on a trend of yield leakage change. In yet another embodiment, the dynamic digital channel journey analysis program 110A, 110B may utilize RNN in step 220 to learn and automatically train that the weighted data value in An may be adjusted based on the frequencies of the paths taken, successful journey and partial journeys obtaining the yield loss for different periods and different AₙXₙ values.

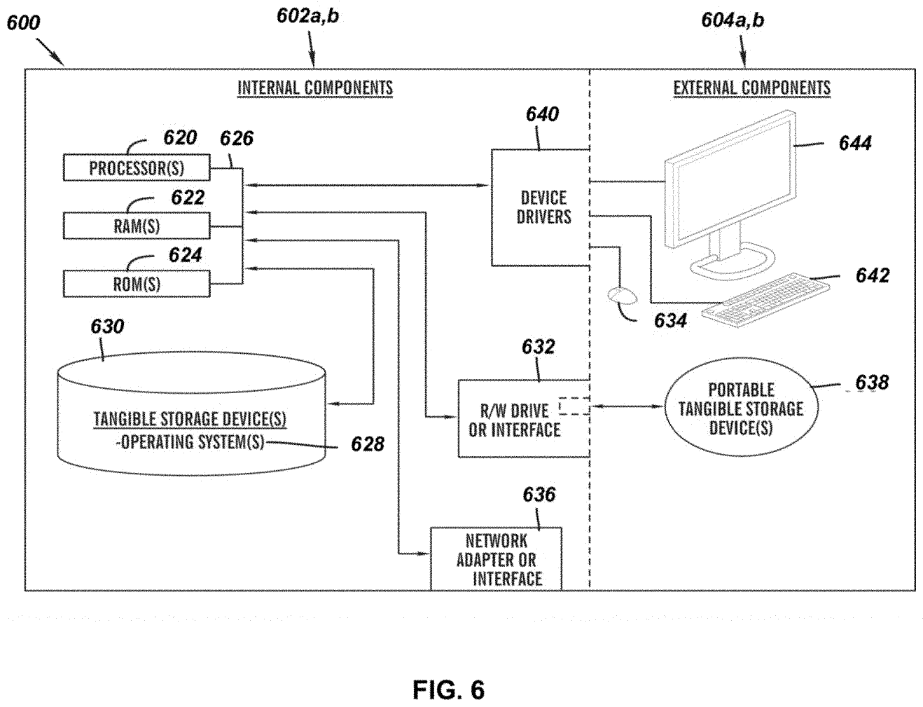

FIG. 6 is a block diagram of internal and external components of the client computing device 102 and the server 112 depicted in FIG. 1 in accordance with an embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

The data processing system 602, 604 is representative of any electronic device capable of executing machine-readable program instructions. The data processing system 602, 604 may be representative of a smartphone, a computer system, PDA, or other electronic devices. Examples of computing systems, environments, and/or configurations that may represented by the data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 602 a,b and external components 604 a,b illustrated in FIG. 6. Each of the sets of internal components 602 include one or more processors 620, one or more computer-readable RAMs 622, and one or more computer-readable ROMs 624 on one or more buses 626, and one or more operating systems 628 and one or more computer-readable tangible storage devices 630. The one or more operating systems 628, the software program 108 and the dynamic digital channel journey analysis program 110A in the client computing device 102 and the dynamic digital channel journey analysis program 110B in the server 112 are stored on one or more of the respective computer-readable tangible storage devices 630 for execution by one or more of the respective processors 620 via one or more of the respective RAMs 422 (which typically include cache memory). In the embodiment illustrated in FIG. 6, each of the computer-readable tangible storage devices 630 is a magnetic disk storage device of an internal hard drive. Alternatively, each of the computer-readable tangible storage devices 630 is a semiconductor storage device such as ROM 624, EPROM, flash memory or any other computer-readable tangible storage device that can store a computer program and digital information.

Each set of internal components 602 a,b also includes an R/W drive or interface 632 to read from and write to one or more portable computer-readable tangible storage devices 638 such as a CD-ROM, DVD, memory stick, magnetic tape, magnetic disk, optical disk or semiconductor storage device. A software program, such as the dynamic digital channel journey analysis program 110A, 110B can be stored on one or more of the respective portable computer-readable tangible storage devices 638, read via the respective R/W drive or interface 632 and loaded into the respective hard drive 630.

Each set of internal components 602 a,b also includes network adapters or interfaces 636 such as a TCP/IP adapter cards, wireless Wi-Fi interface cards, or 3G or 4G wireless interface cards or other wired or wireless communication links. The software program 108 and the dynamic digital channel journey analysis program 110A in the client computing device 102 and the dynamic digital channel journey analysis program 110B in the server 112 can be downloaded to the client computing device 102 and the server 112 from an external computer via a network (for example, the Internet, a local area network or other, wide area network) and respective network adapters or interfaces 636. From the network adapters or interfaces 636, the software program 108 and the dynamic digital channel journey analysis program 110A in the client computing device 102 and the dynamic digital channel journey analysis program 110B in the server 112 are loaded into the respective hard drive 630. The network may comprise copper wires, optical fibers, wireless transmission, routers, firewalls, switches, gateway computers and/or edge servers.

Each of the sets of external components 604 a,b can include a computer display monitor 644, a keyboard 642, and a computer mouse 634. External components 604 a,b can also include touch screens, virtual keyboards, touch pads, pointing devices, and other human interface devices. Each of the sets of internal components 602 a,b also includes device drivers 640 to interface to computer display monitor 644, keyboard 642, and computer mouse 634. The device drivers 640, R/W drive or interface 632, and network adapter or interface 636 comprise hardware and software (stored in storage device 630 and/or ROM 624).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

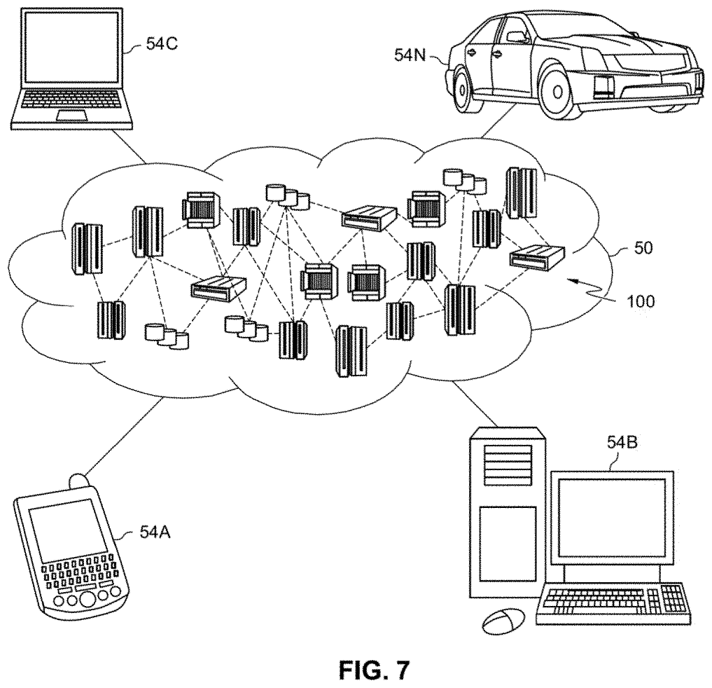

Referring now to FIG. 7, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

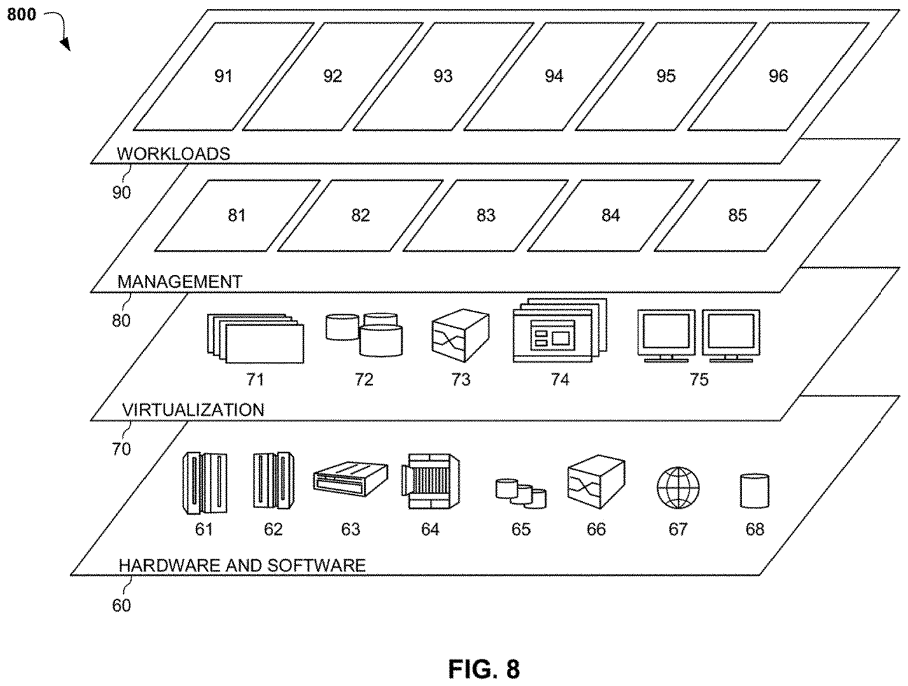

Referring now to FIG. 8, a set of functional abstraction layers 800 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic digital channel journey analysis 96. The dynamic digital channel journey analysis 96 may relate to creating a vector graph to dynamically analyze digital channel journey from a request for a service to subsequent pages and to identify where a yield loss is the highest.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for dynamic digital channel journey analysis, the method comprising:
obtaining information related to user page accesses and flows;
creating a period graph for a measurement period;
computing an initial yield leakage value for the measurement period;
creating a temporal reference,
updating the period graph based on the yield leakage value and the temporal reference; and
identifying a link where the yield leakage value is high and where the link leads to.

2. The method of claim 1, further comprising:
determining an engagement level on one or more webpages the user accesses.

3. The method of claim 1, further comprising:
determining a coefficient value, wherein the coefficient value is “n x n” matrix and has “w” layers based on the level of user engagement.

4. The method of claim 1, further comprising:
determining an edge value representing a number of unique traversals between two nodes in the period graph.

5. The method of claim 1, further comprising:
determining a value representing steps to completion of a transaction in a flow, and
applying the value when there are exits without completion of a transaction.

6. The method of claim 3, further comprising:
updating the coefficient value when there is an increase in the yield leakage value.

7. The method of claim 3, further comprising:
training a deep learning system when the yield leakage value changes; and
updating a corresponding coefficient value.

8. A computer system for dynamic digital channel journey analysis, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
obtaining information related to user page accesses and flows;
creating a period graph for a measurement period;
computing an initial yield leakage value for the measurement period;
creating a temporal reference,
updating the period graph based on the yield leakage value and the temporal reference; and
identifying a link where the yield leakage value is high and where the link leads to.

9. The computer system of claim 8, further comprising:
determining an engagement level on one or more webpages the user accesses.

10. The computer system of claim 8, further comprising:
determining a coefficient value, wherein the coefficient value is “n x n” matrix and has “w” layers based on the level of user engagement.

11. The computer system of claim 8, further comprising:
determining an edge value representing a number of unique traversals between two nodes in the period graph.

12. The computer system of claim 8, further comprising:
determining a value representing steps to completion of a transaction in a flow; and
applying the value when there are exits without completion of a transaction.

13. The computer system of claim 10, further comprising:
updating the coefficient value when there is an increase in the yield leakage value.

14. The computer system of claim 10, further comprising:
training a deep learning system when the yield leakage value changes; and
updating a corresponding coefficient value.

15. A computer program product for dynamic digital channel journey analysis, the computer program product comprising:
one or more computer-readable tangible storage media and program instructions stored on at least one of the one or more tangible storage media, the program instructions executable by a processor of a computer to perform a method, the method comprising:
obtaining information related to user page accesses and flows;
creating a period graph for a measurement period;
computing an initial yield leakage value for the measurement period;
creating a temporal reference,
updating the period graph based on the yield leakage value and the temporal reference; and
identifying a link where the yield leakage value is high and where the link leads to.

16. The computer program product of claim 15, further comprising:
determining an engagement level on one or more webpages the user accesses.

17. The computer program product of claim 15, further comprising:
determining a coefficient value, wherein the coefficient value is “n x n” matrix and has “w” layers based on the level of user engagement.

18. The computer program product of claim 15, further comprising:
determining a value representing steps to completion of a transaction in a flow; and
applying the value when there are exits without completion of a transaction.

19. The computer program product of claim 17, further comprising:
updating the coefficient value when there is an increase in the yield leakage value.

20. The computer program product of claim 17, further comprising:
training a deep learning system when the yield leakage value changes; and
updating a corresponding coefficient value.
